(19) United States
(12) Patent Application Publication
(10) Pub. No.: US 2021/0180386 A1
(43) Pub. Date: Jun. 17, 2021

(54) Wireless safety system for Gate Opening Apparatus

(71) Applicant: Qianliang QIU, Arcadia, CA (US)

(72) Inventor: Qianliang QIU, Arcadia, CA (US)

(21) Appl. No.: 16/714,511

(22) Filed: Dec. 13, 2019

(51) Int. Cl. E05F 15/43

(52) U.S. Cl. CPC E05F 15/43

(57) ABSTRACT

A wireless safety system for a gate opening apparatus includes a main housing, a transmitter unit, a reflection device mounted at a distance from the transmitter unit and optically communicated with the transmitter unit, a receiver unit supported in the main housing and arranged to receive optical signal reflected from the reflection device, and an positioning device. The positioning device includes a light emitter mounted in the main housing at a position adjacent to the transmitter unit. The light emitter is arranged to emit positioning light beam at a same direction as that of the optical signal emitted from the transmitter unit and is arranged to produce a colored indication on a targeted object as a proper position of the reflection device.

### BACKGROUND OF THE PRESENT INVENTION

### Field of Invention

The present invention relates to a gate opening apparatus, and more particularly to a wireless safety system for a gate opening apparatus comprising a positioning device which is capable of allowing a user to conveniently and precisely position the wireless safety system for working with the gate opening apparatus.

### Description of Related Arts

A conventional gate opening apparatus may be utilized for actuating sliding movement of a door gate. The gate opening apparatus may be connected to the gate through a plurality of chains. A common feature of the above-mentioned gate opening apparatus is that some sorts of safety devices will be employed to make sure that when an object, such as a car or a human body, is passing through a specific area, the gate will not be actuated so as to avoid the gate from hitting the object.

A common safety device for the conventional gate opening apparatus as described above is a wireless safety system. The wireless safety system may utilize wireless technology, such as infrared radiation or photocell sensors, for detecting the presence or absence of an object in front of the gate. The wireless safety system may comprise a transmission unit mounted on one side of the gate and a receiver unit mounted at a distance from the transmission unit, usually opposite to the transmission unit. In normal circumstances, the signal transmitted from the transmission unit will be received by the receiver so that any interruption of the signal may indicate an object is blocking the entrance of the gate. The detection of interruption of the wireless signal may cause a control unit to temporarily stop actuating the gate until the wireless signal is received again.

A common problem with the above-mentioned gate opening apparatus and the wireless safety system is that it is very hard to properly align the transmission unit with the receiver unit when installing the gate opening apparatus and the wireless safety system. A common practice is to utilize a reflective mirror for measuring or locating the proper position of the receiver unit. Since the wireless signal is usually invisible, a technician will have a very hard time in locating the possible position of the receiver unit. The possible position of the receiver unit may be several feet away from and opposite to the transmission unit. The entire installation process of the wireless safety system may take several hours which is very time-consuming.

As a result, there is a need to improve upon conventional gate opening apparatuses and wireless safety system so as to resolve the above-mentioned problems.

### SUMMARY OF THE PRESENT INVENTION

Certain variations of the present invention provide a wireless safety system for a gate opening apparatus comprising a positioning device which is capable of allowing a user to conveniently and precisely position the wireless safety system for working with the gate opening apparatus.

Certain variations of the present invention provide a wireless safety system comprising a transmitter unit, a reflection device, a receiver unit and a positioning device which is arranged to assist positioning of the reflection device so as to allow proper optical communication between the transmitter unit and the receiver unit.

Certain variations of the present invention provide a wireless safety system for a gate opening apparatus for a door gate, comprising:

a main housing;

a transmitter unit supported in the main housing and arranged to emit optical signal at a predetermined direction;

a reflection device mounted at a distance from the transmitter unit and optically communicated with the transmitter unit;

a receiver unit supported in the main housing and arranged to receive optical signal reflected from the reflection device; and

a positioning device, which comprises an light emitter mounted in the main housing at a position adjacent to the transmitter unit, the light emitter being arranged to emit positioning light beam at a same direction as that of the optical signal emitted from the transmitter unit, the positioning light beam being arranged to produce a colored indication on a targeted object as a proper position of the reflection device, whereby a user is able to mount the reflection device on the targeted object for properly and optically communicating with the transmitter unit.

This summary presented above is provided merely to introduce certain concepts and not to identify any key or essential features of the claimed subject matter.

### BRIEF DESCRIPTION OF THE DRAWINGS

FIG. 1 a perspective view of a wireless safety system according to a preferred embodiment of the present invention.

FIG. 2 is an exploded perspective view of the wireless safety system according to the preferred embodiment of the present invention.

FIG. 3 is a block diagram of the wireless safety system according to the preferred embodiment of the present invention.

FIG. 4 is a schematic diagram of the wireless safety system in use with a gate opening apparatus according to the preferred embodiment of the present invention.

FIG. 5 is a perspective view of a reflection device according to the preferred embodiment of the present invention.

FIG. 6 a perspective view of a mounting bracket of the wireless safety system according to the preferred embodiment of the present invention.

FIG. 7 is an illustrative side view of the wireless safety system according to the preferred embodiment of the present invention.

FIG. 8 an illustrative front view of the wireless safety system according to the preferred embodiment of the present invention.

### DETAILED DESCRIPTION OF THE PREFERRED EMBODIMENT

The following detailed description of the preferred embodiments is the preferred mode of carrying out the invention. The description is not to be taken in any limiting sense. It is presented for the purpose of illustrating the general principles of the present invention.

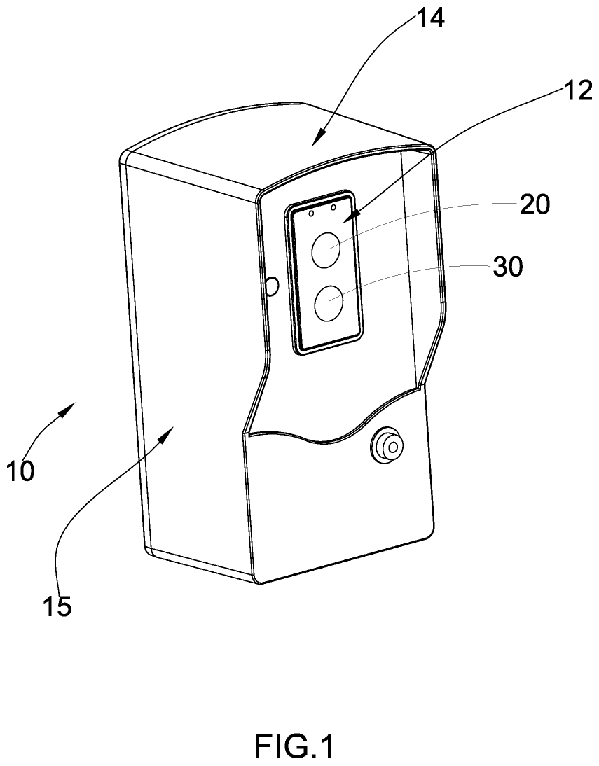

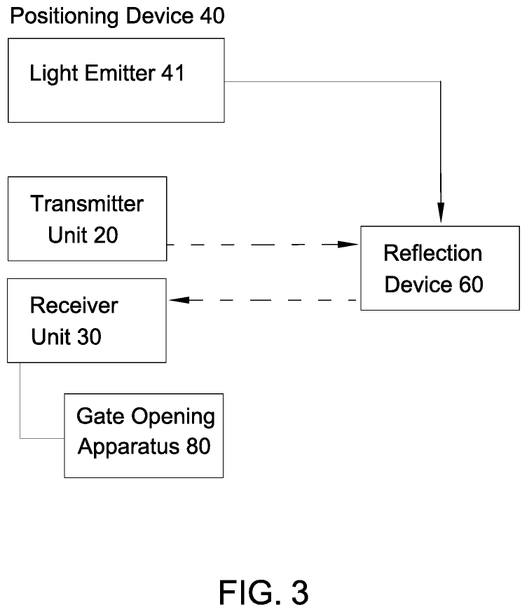

Referring to FIG. 1 to FIG. 8 of the drawings, a wireless safety device for a gate opening apparatus according a preferred embodiment of the present invention is illustrated. Broadly, the wireless safety device may comprise a main housing 10, a transmitter unit 20, a reflection device 60, a receiver unit 30, and a positioning device 40. The wireless safety device may be for a gate opening apparatus 80 for slidably opening and closing a door gate 100 which may comprise at least a transverse member 101 and a longitudinal member 102. The gate opening apparatus 80 may actuate the door gate 100 to move in a slidable manner through a plurality of chains.

The transmitter unit 20 may be supported in the main housing 10 and arranged to emit optical signal at a predetermined direction.

The reflection device 60 may be mounted at a distance from the transmitter unit 20 and optically communicated with the transmitter unit 20.

The receiver unit 30 may be supported in the main housing 10 and arranged to receive optical signal reflected from the reflection device 60.

The positioning device 40 may comprise a light emitter 41 mounted in the main housing 10 at a position adjacent to the transmitter unit 20. The light emitter 41 may be arranged to emit positioning light beam at a same direction as that of the optical signal emitted from the transmitter unit 20, and may be arranged to produce a colored indication on a targeted object as a proper position of the reflection device 60, whereby a user is able to mount the reflection device 60 on the targeted object for properly and optically communicating with the transmitter unit 10.

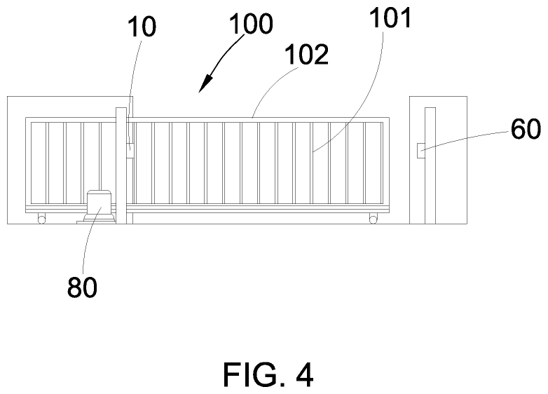

According to the preferred embodiment of the present invention, the main housing 10 may be supported in the vicinity of the gate opening apparatus 80 which may be located in the vicinity of the door gate 100, as exemplified in FIG. 4 of the drawings. The purpose of the present invention is to detect movement in a designated space and temporarily deactivate the gate opening apparatus 80 so as to temporarily stop movement of the door gate 100.

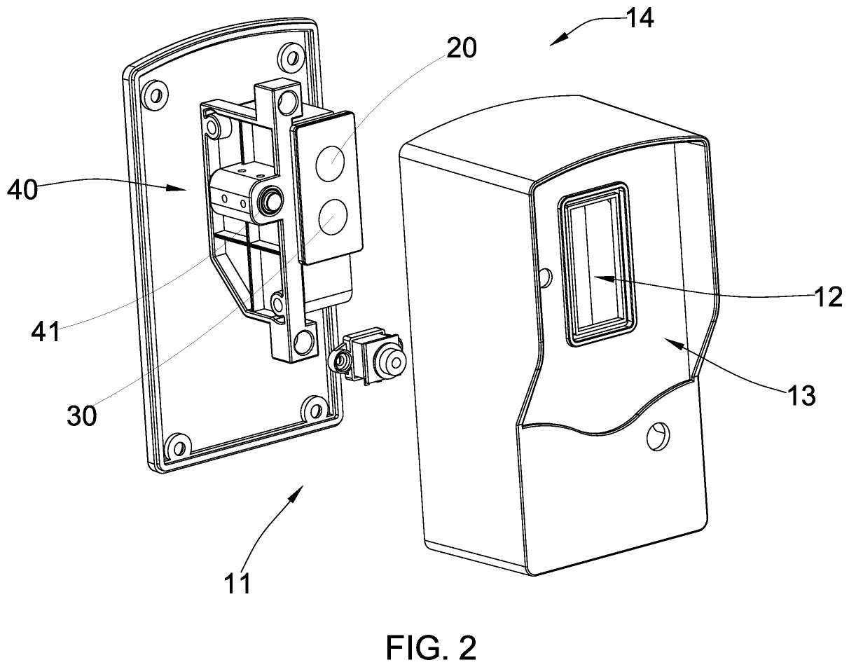

The main housing 10 may have a receiving cavity 11 for accommodating the transmitter unit 20, the receiver unit 30 and the positioning device 40. As shown in FIG. 1 to FIG. 2 of the drawings, the main housing 10 may have a front surface 13, a top surface 14, two side surfaces 15, a rear surface 18 and a bottom surface 17 for forming a substantially rectangular structure. Other geometrical structure and contours are also possible.

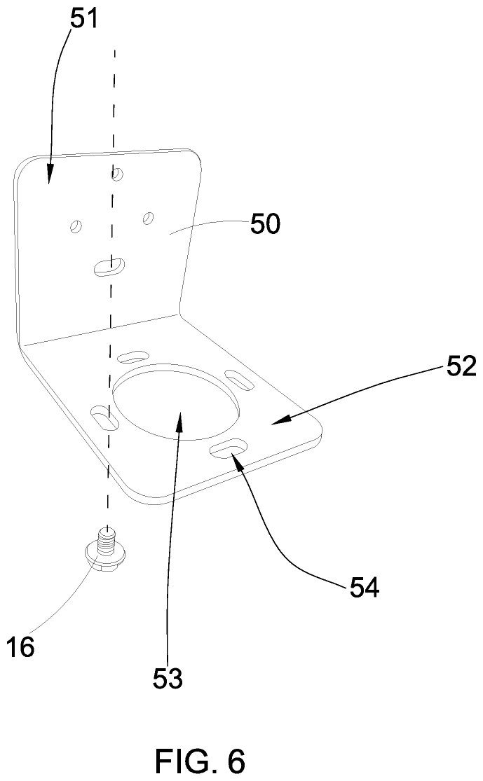

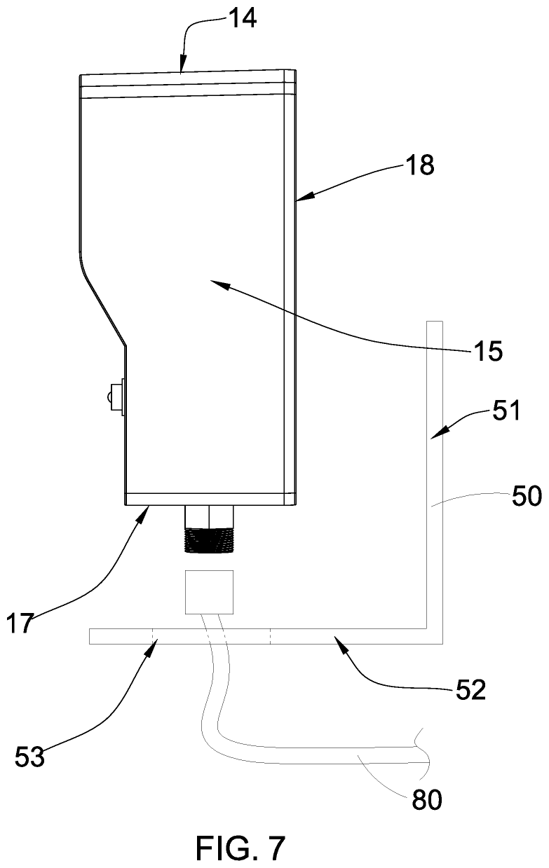

The wireless safety device may further comprise a mounting bracket 50 wherein the main housing 10 may be adjustably and movably mounted on the mounting bracket 50. Referring to FIG. 6 to FIG. 7 of the drawings, the mounting bracket 50 may have a vertical mounting portion 51 and a horizontal mounting portion 52 extended from the vertical mounting portion 51 to form a substantially L-shaped structure. The mounting bracket 50 may have a through hole 53 formed on the horizontal mounting portion 52, and a plurality of guiding slots 54 also formed on the horizontal mounting portion 52.

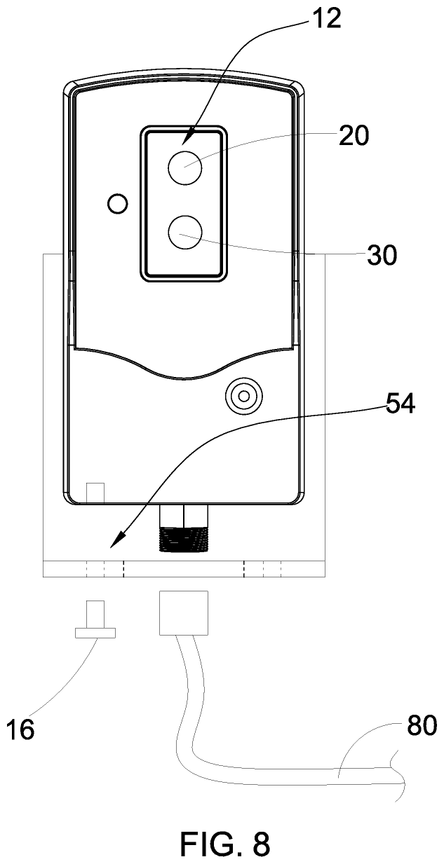

The main housing 10 may be pivotally mounted on the mounting bracket 50 so as to allow a user of the present invention to adjust the angle of inclination of the main housing 10 with respect to the mounting bracket 50. As shown in FIG. 7 to FIG. 8 of the drawings, the adjustment of the angle of inclination may be accomplished through adjusting at least one adjusting screw 16 adjustably connecting a bottom surface 14 of the main housing 10 and the corresponding guiding slot 54. Each of the guiding slots 54 may have a curved cross-sectional shape when viewed from the top. Thus, the adjusting screw 16 may connect the main housing 10 to the mounting bracket 50 through penetrating the corresponding guiding slot 54 and in such a manner that the adjusting screw 16 may slide along the curved guiding slot 54 so as to allow the main housing 10 to be pivotally moved with respect to the mounting bracket 50.

On the other hand, at least one of the transmitter unit 20, the receiver unit 30 and the positioning device 40 may be electrically connected to the gate opening apparatus through electrical cables 80 penetrating the through hole 53 of the mounting bracket 50. The through hole 50 may be formed on central part of the horizontal mounting portion 52 of the mounting bracket 50 while the guiding slots 54 may be formed only on the horizontal mounting portion 52 adjacent to the through hole 53. The guiding slots 54 may be circumferentially surrounding the through hole 53. The through hole 53 may be circular in cross sectional shape when viewed from the top, while a radius of curvature of each of the guiding slots 54 may be approximately the same as the radius of curvature of the through hole 53.

The main housing 10 may further have a light admissible portion 12 formed at a position corresponding to the transmitter unit 20 and the positioning device 40 so that optical signal from the transmitter unit 20 and the positioning device 40 may be transmitted to the reflection device 60 through the light admissible portion 12. In this preferred embodiment, the light admissible portion 12 may be accomplished by constructing the light admissible portion 12 from transparent plastic material or glass material. The remaining portion of the main housing 10 may be configured from metallic or plastic material so that light cannot penetrate the remaining portion of the main housing 10. In this preferred embodiment, the light admissible portion 12 may be formed on the front surface 13 of the main housing 10.

The transmitter unit 20 and the receiver unit 30 may together form a photoelectric sensor. The transmitter unit 20 may be configured to emit light which may travel through the light admissible portion 12 of the main housing 10 and reach the opposite side of the transmitter unit 20. The light emitted from the transmitter unit 20 may be reflected back by the reflection device 60 and re-enter the main housing 10 through the light admissible portion 12 and eventually reach the receiver unit 30. Thus, the transmitter unit 20 and the receiver unit 30 may be supported in the receiving cavity 11 and align with the light admissible portion 12. The receiver unit 30 may be electrically connected to the gate opening apparatus 80 so that any interference of the optical signal may be transmitted to the gate opening apparatus 80 for actuating a corresponding response thereof.

The reflection device 60 may be supported at a position opposite to the main housing 10 and arranged to be disposed along the optical path of the light emitted by the transmitter unit 20. The purpose of the reflection device 60 is to reflect the light emitted from the transmitter unit 20 back to the receiver unit 30.

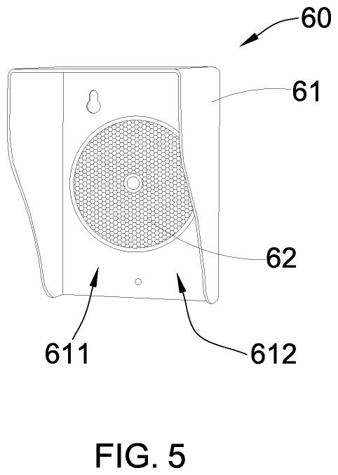

As shown in FIG. 5 of the drawings, the reflective device 60 may comprise a protective cover 61 having a protective cavity 611, and a reflective panel 62 supported in the protective cavity 611. The protective cover 61 is structurally similar to that of the mounting cover 50. A communicating opening 612 is formed for communicating the protective cavity 611 with an exterior of the protective cover 61. The reflective panel 62 may be configured from light-reflective material such as reflective glass so that light may be effectively reflected from the reflective panel 62 when it is impinges upon the reflective panel 62. In this configuration, light emitted from the transmitter unit 20 may reach the reflective panel 62 through the communicating opening 612. The light impinging on the reflective panel 62 may be arranged to be reflected back toward the receiver unit 30.

Therefore, the position of the reflection device 60 with respect to the transmitter unit 20 and the receiver unit 30 is of crucial importance, and this is reflected in the initial installation of the wireless safety system and the gate opening apparatus 80. When the reflection device 60 is improperly positioned, the light from the transmitter unit 20 will not be properly reflected and the receiver unit 30 will not obtain a correct signal for actuating the gate opening apparatus 80.

The positioning device 40 may be utilized to resolve the problem of difficult and inconvenient positioning of the reflection device 60. The positioning device 40 may comprises the light emitter 41 mounted in the main housing 10 at a position adjacent to the transmitter unit 20. The light emitter 41 may be arranged to generate light beam as the positioning light beam for producing a colored indication (such as a red dot) on a surface such as a wall surface.

In this preferred embodiment, the light emitter 41 may comprise a laser pointer which is capable of generating coherent low-power laser beam of visible light, wherein the laser beam may project toward where the reflection device 60 should be mounted. The light beam generated by the light emitter 41 may propagate in a direction parallel to the infrared light generated by the transmitter unit 20 and therefore may guide a technician to mount the reflection device 60 on a proper position. Since the light emitter 41 and the transmitter unit 20 are mounted in the main housing 10 at positions very close to each other, the colored indication on the opposite side of the main housing 10 may indicate a position where the light from the transmitter unit 20 impinges. Thus, when the reflection device 60 is mounted on that particular position, the light emitted from the transmitter unit 20 may impinge upon the reflective panel 612 and may properly be reflected back to the receiver unit 30.

Note that the orientation of the transmitter unit 20 may be adjusted by adjusting the orientation of the main housing 10. By partially unscrewing the adjusting screw 16 from the main housing 10, the main housing 10 may pivotally move with respect to the mounting bracket 50. A user will then be able to adjust the position of the main housing 10 with respect to the reflection device 60 by the indication provided through the illumination of the light emitter 41 on the reflection device 60.

The present invention, while illustrated and described in terms of preferred embodiments and several alternatives, is not limited to the particular description contained in this specification. Additional alternative or equivalent components could also be used to practice the present invention.

What is claimed is:

1. A wireless safety system for a gate opening apparatus for a door gate, comprising:
a main housing;
a transmitter unit supported in said main housing and arranged to emit optical signal at a predetermined direction;
a reflection device mounted at a distance from said transmitter unit and optically communicated with said transmitter unit;
a receiver unit supported in said main housing and arranged to receive optical signal reflected from said reflection device; and
an positioning device, which comprises an light emitter mounted in said main housing at a position adjacent to said transmitter unit, said light emitter being arranged to emit positioning light beam at a same direction as that of said optical signal emitted from said transmitter unit, said positioning light beam being arranged to produce a colored indication on a targeted object as a proper position of said reflection device, whereby a user is able to mount said reflection device on said targeted object for properly and optically communicating with said transmitter unit.

2. The wireless safety system, as recited in claim 1, wherein said main housing further has a light admissible portion formed at a position corresponding to said transmitter unit and said positioning device so that optical signal from said transmitter unit and said positioning device is arranged to be transmitted to said reflection device through said light admissible portion.

3. The wireless safety system, as recited in claim 2, wherein said transmitter unit and said receiver unit form a photoelectric sensor, such that said transmitter unit is configured to emit light which is arranged to travel through said light admissible portion of said main housing and reach said opposite side of said transmitter unit, said light emitted from said transmitter unit being reflected back by said reflection device and re-enter said main housing through said light admissible portion and reach said receiver unit.

4. The wireless safety system, as recited in claim 3, wherein said reflection device is supported at a position opposite to said main housing and is arranged to be disposed along an optical path of said light emitted by said transmitter unit, said reflective device comprising a reflective panel configured from a light-reflective material.

5. The wireless safety system, as recited in claim 4, wherein said light emitter comprises a laser pointer which is capable of generating coherent low-power laser beam of visible light.

6. The wireless safety system, as recited in claim 5, wherein said wireless safety device further comprises a mounting bracket wherein said main housing is adjustably and movably mounted on said mounting bracket for adjusting an orientation of said optical signal.

7. The wireless safety system, as recited in claim 6, wherein said mounting bracket has a vertical mounting portion and a horizontal mounting portion extended from said vertical mounting portion to form a substantially L-shaped structure, said mounting bracket having a plurality of curved guiding slots formed on said horizontal mounting portion, said main housing is adjustably and movably mounted on said mounting bracket through at least one adjusting screw selectively sliding in said corresponding guiding slot.

8. The wireless safety system, as recited in claim 5, wherein said main housing has a receiving cavity for accommodating said transmitter unit, said receiver unit and said positioning device, said main housing further having a front surface, a top surface, and two side surfaces for forming a substantially rectangular structure.

9. The wireless safety system, as recited in claim 7, wherein said main housing has a receiving cavity for accommodating said transmitter unit, said receiver unit and said positioning device, said main housing further having a front surface, a top surface, and two side surfaces for forming a substantially rectangular structure.

10. The wireless safety system, as recited in claim 4, wherein said mounting bracket further has a through hole formed on said horizontal portion, wherein said transmitter unit and said receiver unit are electrically connected to said gate opening apparatus through an electrical cable penetrating through said through hole.

11. The wireless safety system, as recited in claim 8, wherein said mounting bracket further has a through hole formed on said horizontal portion, wherein said transmitter unit and said receiver unit are electrically connected to said gate opening apparatus through an electrical cable penetrating through said through hole.

12. The wireless safety system, as recited in claim 9, wherein said mounting bracket further has a through hole formed on said horizontal portion, wherein said transmitter unit and said receiver unit are electrically connected to said gate opening apparatus through an electrical cable penetrating through said through hole.

13. The wireless safety system, as recited in claim 5, wherein said reflection device further comprises a protective cover having a protective cavity and a communicating opening for communicating said protective cavity with an exterior of said protective cover, said reflective panel being mounted in said protective cavity.

14. The wireless safety system, as recited in claim 9, wherein said reflection device further comprises a protective cover having a protective cavity and a communicating opening for communicating said protective cavity with an exterior of said protective cover, said reflective panel being mounted in said protective cavity.

15. The wireless safety system, as recited in claim 12, wherein said reflection device further comprises a protective cover having a protective cavity and a communicating opening for communicating said protective cavity with an exterior of said protective cover, said reflective panel being mounted in said protective cavity.
